(19) United States
(12) Patent Application Publication
(10) Pub. No.: US 2023/0393949 A1
(43) Pub. Date: Dec. 7, 2023

(54) METHOD AND SYSTEM FOR CREATING A BACK-UP DOCKET

(71) Applicant: Black Hills IP Holdings, LLC, Minneapolis, MN (US)

(72) Inventor: Steven W. Lundberg, Edina, MN (US)

(21) Appl. No.: 18/205,982

(22) Filed: Jun. 5, 2023

Related U.S. Application Data
(60) Provisional application No. 63/348,869, filed on Jun. 3, 2022.

(51) Int. Cl. G06F 11/14; G06Q 10/10

(52) U.S. Cl. CPC G06F 11/1464; G06F 11/1448; G06Q 10/103

(57) ABSTRACT

Various embodiments disclosed relate to backup dockets and docket requirement auditing. The present disclosure includes a method including maintaining a primary docketing system, calculating, using a first template, a primary due date associated with a docket item, docketing the primary due date in the primary docketing system, calculating, using a second template, a secondary due date associated with the docket item, wherein the secondary due date is duplicative of the primary due date, and comparing the primary due date with the secondary due date. The present disclosure includes a method including receiving a first requirement, wherein the first requirement is received from a third party, docketing the first requirement in an internal docketing system, and creating an annotation in the internal docketing system, the annotation associated with the first requirement, wherein the annotation describes input parameters relating to the origin of the first requirement.

### CLAIM OF PRIORITY

This application claims the benefit of priority under 35 U.S.C. § 119(e) to U.S. Patent Application Ser. No. 63/348,869, filed on Jun. 3, 2022, which is incorporated by reference herein in its entirety.

### BACKGROUND

In a business, docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that may require a response. However, in a general docketing setting, a large number of items and tasks are incoming and often need to be sorted during docketing. In some instances, cross-checking or auditing of docketed items is desired.

### SUMMARY OF THE DISCLOSURE

The present disclosure provides a method of leveraging a secondary, external patent docket, as a back-up for priority dates and items in a primary, automated docketing system. In this method, a number of priority dates and items can be identified in the first docket, such as deadlines for a continuation filing, a divisional filing, a conversion filing, a non-provisional filing, a PCT filing, a national stage filing, or other items. Categories of priority items can also be determined. These priority items can be taken from a secondary docket maintained by a third party, such as a client or governmental agency. Copies of these items from the secondary docket can be imported into the primary, automated docket. Cross-checking can be done to ensure a fail-safe for priority dates.

Additionally, discussed herein is a due date audit and verification method and tool for use in an automated or semi-automated docketing system. The method allows for insertion of notes or annotations into a docketing system when a due date is created, so that a user later checking the due date understands where the due date originated and how.

For example, when docketing items are incoming from a patent office, due dates can be calculated based on the mailing date of an incoming item. For example, such a calculated due date could be manually calculated internally, provided by the patent office itself, or calculated automatically, such as by a template program. If a user wants to return and see the docketed dates for that docketing item, they rarely know where or how the due date was calculated, and it is unlikely they understand the source of the due date.

Discussed herein is a due date checker tool and a backup docket tool which helps to audit, confirm, and explain calculated due dates and deadlines in a docket system. The methods and systems of due date checker tools and backup docket tools, which can be automated, can additionally provide parameters for how deadlines have been calculated. These tools can additionally allow for annotations noting where a deadline has been updated and why, such as when a user modifies a deadline manually.

The discussed methods and systems here have a variety of advantages, some of which are unexpected. For example, the production of a back-up docket and crossing-checking of due dates can help ensure tasks are done in a timely manner and deadlines are not missed. Additionally, the use of annotations for origin of deadlines can help practitioners understand where and how deadlines are produced or updated.

In an example, a method of creating a back-up docket includes maintaining a primary docketing system; calculating, using a first template, a primary due date associated with a docket item; docketing the primary due date in the primary docketing system; calculating, using a second template, a secondary due date associated with the docket item, wherein the secondary due date is duplicative of the primary due date; and comparing the primary due date with the secondary due date.

In an example, a system for creating back-up dockets includes: a first docketing system configured to docket and maintain a patent portfolio in an automated or semi-automated manner, the first docketing system having a first template which when executed calculates a first due date based on a base date; a second docketing system separate from the first docketing system, the second docketing system configured to maintain the patent portfolio, the second docketing system having a second template which when executed calculates a second due date based on a base date; and a back-up docketing tool actuatable for comparing the first due date and the second due date.

In an example, a computer readable medium includes a memory and a processor, the processor configured to: maintain a first docket in a semi-automated or automated system; select, from the first docket, one or more docketed priority items; identify, in a second docket separate from the first docket, equivalents of the one or more docketed priority items; collect the equivalents of the one or more pocketed priority items; and docket the equivalents of the one or more docketed priority items in the first docket as back-up priority items.

In an example, a method includes: receiving a first requirement, wherein the first requirement is received from a third-party; docketing the first requirement in an internal docketing system; creating an annotation in the internal docketing system, the annotation associated with the first requirement, wherein the annotation describes input parameters relating to the origin of the first requirement.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of a docketing system in an example.

FIG. 2 illustrates sample third party data sources that provide docketing data input for an automated docketing system implemented for managing patent portfolios in a sample embodiment.

FIG. 3 illustrates a system for creating a back-up docket in an example.

FIG. 4 illustrates a method for creating a back-up docket in an example.

FIG. 5 illustrates a system for confirming a due date in an example.

FIGS. 6A-6C illustrate methods for checking and confirming due dates in an example.

FIG. 7 illustrates a block diagram of an example computing machine upon which any one or more of the techniques or methodologies discussed herein may be implemented.

### DETAILED DESCRIPTION

The present disclosure describes, among other things, a back-up docketing and due date checking system with associated methods. Such methods can be used, for example, in intellectual property docketing system, such as patent docketing system, in the tracking of tasks, deadlines, and other requirements. Discussed herein are semi-automated and automated methods for double checking such docketing system and tasks, such as by creating a back-up docket and double checking important due dates.

Discussed herein are methods and systems for docketing incoming items, such as documents or messages, for a given file, and creating a back-up docket or confirmation of deadlines. The item to be docketed can be received from any of a variety of sources, such as an outside database, external or internal associate, a governmental agency, or other source. The item to be docketed can be one of a variety of types of items to be docketed for that type of file.

As used herein, “electronic communication” refers to an electronic message or a method of exchanging messages between people using electronic devices.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

As used herein, “template” can include a preset format for a document or file, used so that the format does not have to be recreated each time it is used. In some cases, a template can include one or more fields to be filled out.

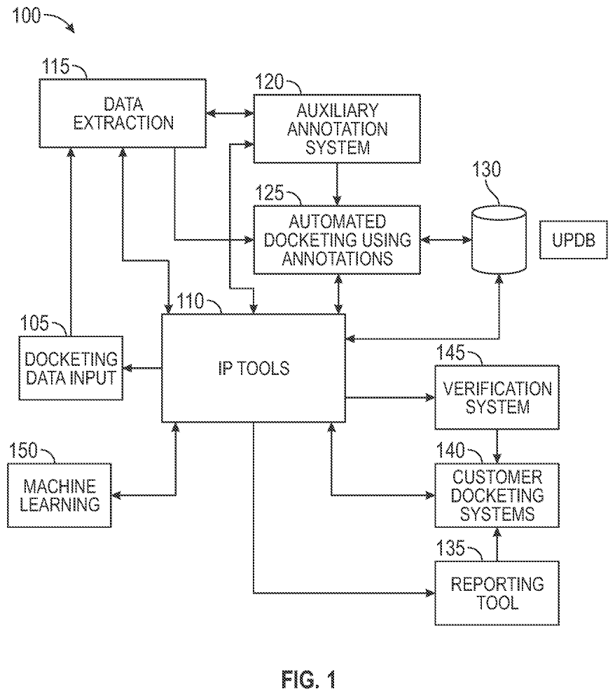

FIG. 1 is a block diagram of a docketing system 100 in an example. The docketing system 100 can be automated or semi-automated. The docketing system 100 can include docketing data input 105, docketing manager 110, data extraction 115, auxiliary annotation system 120, automated docketing using annotations 125, Universal Procedures Database 130, reporting tool 135, customer docketing system 140, verification system 145, and machine learning 150.

The automated docketing system 100 can receive documents from third-party sources including third-party docketing systems and/or customer data as docketing data input 105. The docketing manager system 110 can process the received documents to provide to the customer docketing systems 140 and prepare the documents for data extraction by the data extraction system 115 as needed.

The data extraction system 115 can perform Optical Character Recognition (OCR) on the received documents from the docketing manger system 110 to extract data, read checkboxes, extract lists, and identify documents where possible. The docketing manager system 110 can also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manger system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into the customer's docketing system 140, for example. The template can be filled out by pulling in attributes from the annotations in a document.

The docketing manager system 110 can receive or intake documents and docketing data from several different sources of docketing data input 105, validate the docketing items against entries in a customer's docketing system 140, and communicate those documents to the customer's docketing system 140 via a unified interface. The docketing manager system 110 can also route documents and associated docketing data through the data extraction system 115 and the AAS 120 and organizes the returned metadata and annotations. The docketing manager system 110 thus can provide a breakout between the metadata and the document text.

The docketing manager system 110 can also keep records and communicate with third-party application programming interfaces (APIs) to push the docketing data and documents automatically where allowed. Otherwise, the docketing manager system 110 can present the documents to human docketers to docket. The docketing manager system 110 may also issue reports upon request.

The docketing manager system 110 can be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update the customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into the customer's docketing system 140.

On the other hand, if the docketing manager system 110 and the customer's docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that use a set of rules to verify proper docketing in a host system. The verification system 145 can verify that the data is correctly added to the external customer's docketing system 140. For example, the verification system 145 can pull data from the AAS 120, the docketing manager system 110, and the customer's docketing system 140 to compare what is present to what is expected to be present in the respective systems.

The automated docketing system 100 may also provide automated “report out” email notifications to customers by implementing a reporting tool 135 that specifies docketing actions based on UPDB template configurations. The reporting tool 135 can also provide completed docketing reports to customers either directly or via the customers' docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 can learn which PTO IDs to use for which documents, which document in a bundle of documents may be used to characterize the bundle and may provide predicted PTO IDs for the received documents. The machine learning model system 150 can also establish rule engine prediction capabilities for received documents that test the classifications.

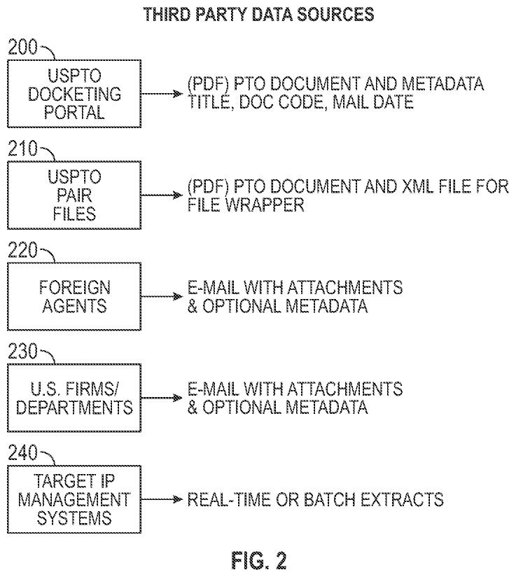

FIG. 2 illustrates sample third-party data sources that provide docketing data input 105 for an automated docketing system 100 implemented for managing patent portfolios in an example. As illustrated in FIG. 2, the third-party data sources may include the Patent Office (e.g., USPTO) docketing portal 200, which provides documents from the USPTO in portable document format (PDF) and includes metadata identifying the title, document code, and mail date for the corresponding document. The third-party data sources may further include USPTO PAIR extensible markup language (XML) files 210, which provide documents from the USPTO in PDF format and includes an XML file for patent file wrappers. The third-party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third-party docketing systems 240 may provide real-time or batch extracts of data for entry into a docketing management system.

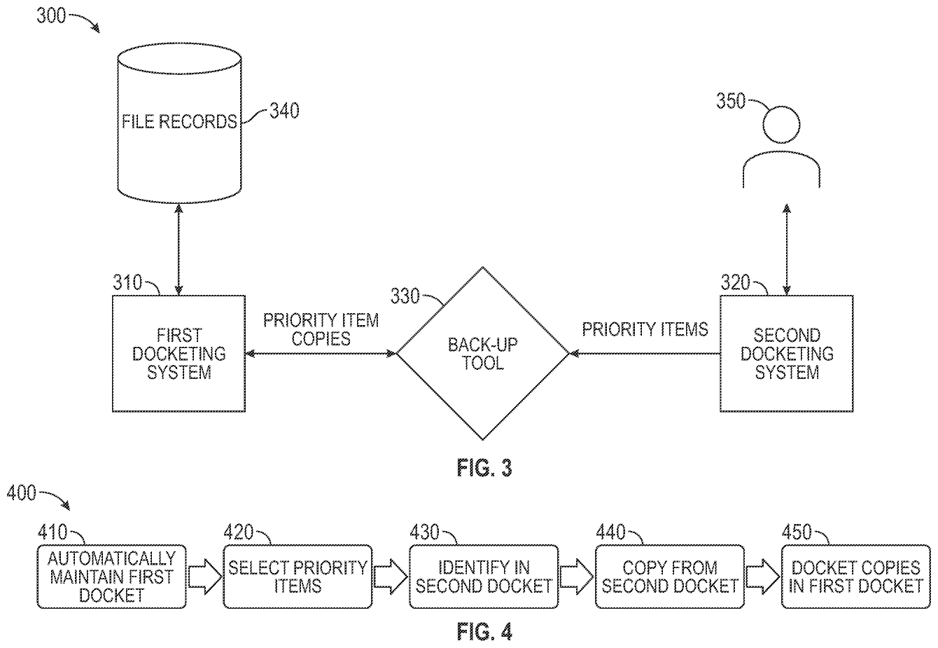

FIG. 3 illustrates a system 300 for creating a back-up docket in an example. The system 300 can include a first docketing system 310, a second docketing system 320, and a back-up tool 330, along with file records 340 and third party 350.

The first docketing system 310 can, for example, be an automated or semi-automated docketing system such as the system discussed above with reference to FIG. 1. The first docketing system 310 can be for docketing and maintenance of a patent portfolio. The second docketing system 320 can be a system separate from the first docketing system. The second docketing system 320 can be for maintaining a patent portfolio. In some cases, the first docketing system 310 can be a privately held and operated docketing system, such as an internal docketing system at a company or firm. In some cases, the second docketing system 320 can be an external docketing system, such as a governmental database or a third-party system. The first docketing system 310 and the second docketing system 320 can be maintained by different parties.

The second docketing system 320 can, for example, be maintained by the third party 350. The third party 350 can be, for example, an external party such as outside counsel, corporate counsel, inside counsel, a legal advisory or consulting organization, a governmental organization, or other third party maintain the second docketing system 320. The first docketing system 310 can be an internal system in communication with internal records, such as file records 340. The file records 340 can include, for example, file histories, deadline, past communications, and other items related to relevant filings or cases.

The first docketing system 310 can have a first template, which when executed calculates a first due date based on a base date. The second docketing system 320 can have a second template which when executed calculates a second due date based on a base date. For example, a base date can be provided, such as a mailing date of an office action from the patent office. The base date, in this case the mailing date, can be used in the first docketing system 310 to calculate a first due date. In order to calculate the first due date, a first template on the first docketing system 310 can be used to convert the base date (e.g., the mailing date) to the first due date. Subsequently or simultaneously, the base date (e.g., the mailing date) can be inputted into the second docketing system 320, and the second docketing system 320 can produce a second due date from the base date.

The system can include a back-up tool 330 actuatable for comparing the first due date from the second due date. In some cases, the back-up tool 330 can be integrated into the first docketing system 310, the second docketing system 320, or both. In some cases, the back-up tool 330 can be a standalone tool that is in communication with the first docketing system 310, the second docketing system 320, or both.

The back-up docketing tool 330 can include a cross-check function. For example, where the first due date is calculated and the second due date is calculated, the back-up docketing tool 330 can compare the calculated dates to ensure that the same date was calculated in both systems.

The back-up docketing tool 330 can be configurable to select priority items for copying to the first docketing system. For example, where a discrepancy occurs between the first due date and the second due date, the back-up docketing tool 330 can copy the earlier due date to the first docketing system 310, the second docketing system 320, or both.

Moreover, the back-up docketing tool 330 can create annotations or embedded notes in each of the template-produced due dates and deadlines. For example, when the first due date is calculated, the back-up docketing tool 330 can note that the first due date was calculated automatically with the first template. Similarly, when the second due date is calculated, the back-up docketing tool 330 can note that the second due date was calculated automatically with the second template. Thus, in future use, a user can see where and how deadlines were calculated or updated.

FIG. 4 illustrates a method 400 for creating a back-up docket in an example. The method 400 can include blocks 410 to 450.

First, at block 410, a primary docketing system can be maintained. For example, the primary docketing system can be an automated or semi-automated docketing system, such as the docketing system discussed with reference to FIG. 1 above. At block 420, in the primary docketing system, a primary due date can be calculated associated with a preliminary docket item, such as a deadline or document. In some cases, the preliminary docket item can be specifically selected for review.

The preliminary docket item can include one or more communications, deadlines, documents, or combinations thereof. In some cases, the preliminary docket item can include a priority date in a patent portfolio. In some cases, such a priority date can include a deadline for a continuation filing, a divisional filing, a conversion filing, a non-provisional filing, a PCT filing, a national stage filing, or combinations thereof.

A primary due date can be calculated, for example, with a template in the primary docketing system. For example, a template in the primary docketing system can be selected based on the source of the item to be docketed or the type of the item to be docketed. The template can include various requirements for information to be supplied to docket the item. The template can be implemented, such as by being filled out, based on the item to be docketed. This can allow for production of information or data relating to the item to be docketed. This information can be sent to a receiving system, where one or more actions or tasks can be executed based on the information produced by the template. In some cases, the template can be provided, such as from an internal system.

In this instance, a primary deadline can be produced in the primary docketing system based on the primary template selected. The calculated primary due date can be based on a preliminary date or document. At block 430, the calculated primary due date can be docketed in the primary docketing system.

At block 440, a secondary template can be used to calculate a secondary due date associated with the docket item. In some cases, the secondary template can be obtained from a secondary docketing system, an external system, or a third-party system. A third-party system can include, for example, a governmental database, a foreign associate, an outside firm, or a client company. For example, in a secondary docketing system, a secondary template can be used to produce a secondary due date. The secondary due date can sometimes be docketed in a secondary docketing system. The secondary due date can be based on the same preliminary date or document. Thus, the secondary due date may be duplicative of the primary due date.

At block 450, the primary due date and the secondary due date can be compared to ensure proper docketing of the preliminary date or document. In some cases, comparing the primary due date with the secondary due date can include cross-checking the docket item. In some cases, the method can additionally include identifying one or more errors in the primary docketing system upon cross-checking, and potentially rectifying the one or more errors in the primary docketing system.

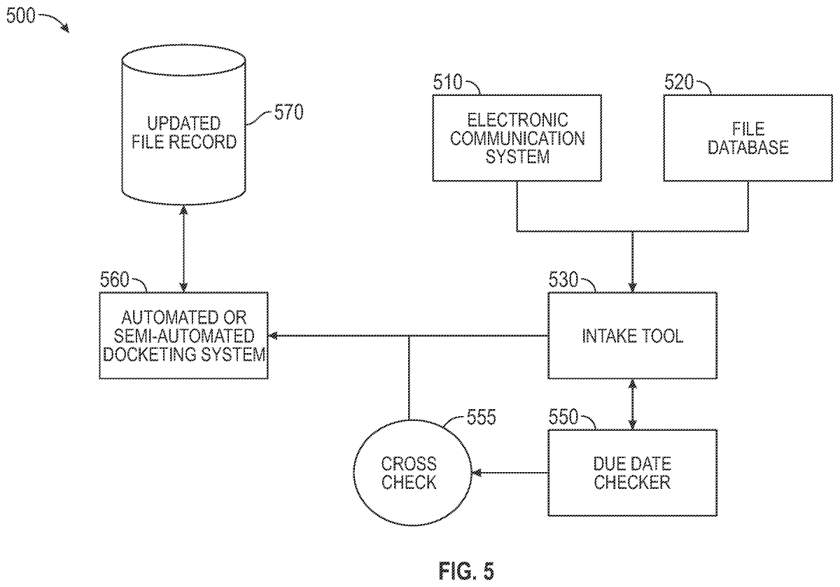

FIG. 5 illustrates a system 500 for confirming a due date in an example. The system 500 can include an electronic communication system 510, a file database 520, an intake tool 530, a due date checker 550, a cross-check step 555, a docketing system 560, and updated file records 570.

The electronic communication system 510 can be, for example, an e-mail server or other communication system. The file database 520 can include a repository of files or projects being working on by the company.

The intake tool 530 can include a program or application for receiving electronic communications and associated documents or files. In some cases, the intake tool 530 can be configured to analyze incoming documents to determine if a particular template is appropriate for calculating associated due dates and docket tasks. In some cases, the intake tool 530 can be a user interface for interaction with a user. In this case, the user can identify and select docket items.

The due date checker 550 can be a tool configured to work with the docketing system 560 as items come in through the intake tool 540. In some cases, the due date checker 550 can be a back-up tool actuatable for comparing calculated due dates. In some cases, the due date checker 550 can be integrated into the one or more docketing systems. In some cases, the due date checker 550 can be a standalone tool that is in communication with docketing systems.

In some cases, the due date checker 550 can be actuatable for calculating due dates. For example, if a new item comes in through the intake tool 530, the intake tool 530 and/or the due date checker 550 can determine what kind of item it is, and the appropriate template to apply to that item. The template can be executed to produce, for example, a deadline.

At the cross-check step 555, the due date checker 550 can then compare the calculated deadline to deadline calculated externally to the system 500. For example, the due date checker 550 can compare the calculated deadline to a deadline provided by a governmental agency or other third-party system.

The docketing system 560 can be an automated or semi-automated docketing system, such as the docketing system discussed above with reference to FIG. 1. The docketing system 560 can be in communication with the intake tool 530 and due date checker 350, and can receive documents, tasks, and communications with the intake tool 530. The docketing system 560 can communicate with and update the file records 570.

The file records 570 can, for example, be a local or cloud-based file storage system including information of files and projects being worked on or monitored by the company. The file records 570 can contain historical records, such as past events, communications, and decisions in each file.

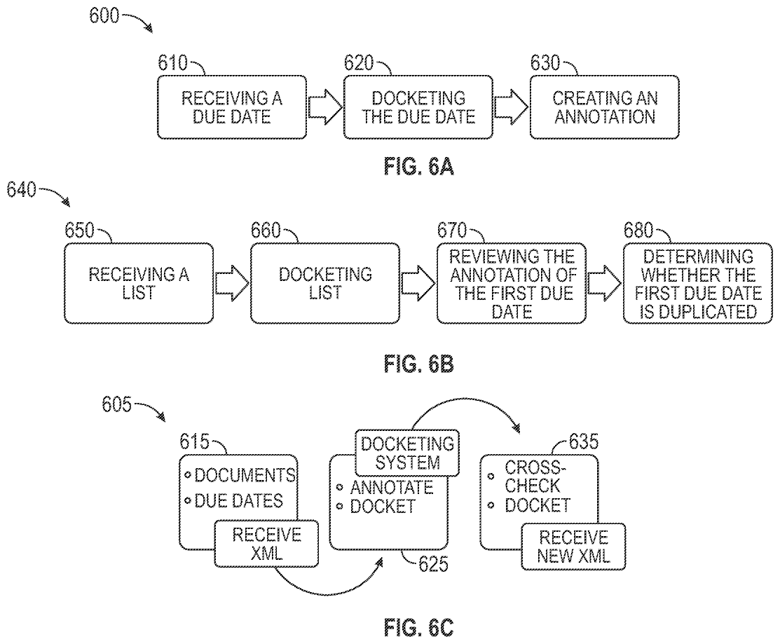

FIGS. 6A-6C illustrate methods for checking, auditing, and confirming due dates in an example.

In FIG. 6A, a method 600 can include blocks 610 to 630. At block 610, a first requirement can be received from a third party. The first requirement can be, for example, a deadline or task, such as associated with a communication or document. For example, a foreign associate can send an e-mail with a new search report from their patent office. At block 620, the first requirement can be docketed in an internal docketing system. For example, the new search report from the foreign associate can be docketed, where the e-mail and the search report are uploaded to the docketing system, and an associated deadline is recorded. At block 630, an annotation can be created and associated with the first requirement docketed in the internal docketing system. Here, the annotation can describe input parameters related to the origin of the first requirement. For example, the annotation can describe the third-party identity and the way in which and timing at which the first requirement was received. In the example of the new search report from the foreign associate, such an annotation can tell the identity of the foreign associate as the source of the docketed item.

In FIG. 6B, a method 640 can include blocks 650 to 670. The method 640 can, for example, follow the method of FIG. 6A. At blocks 650, a list of items to be docketed can be received, each of which can be associated with one or more requirements. For example, a new communication directly from the foreign patent office can be received, which may include one or more documents and associated deadlines, such as for a response to the search report. At block 660, the list is reviewed and docketed, each of the plurality of new requirements having an annotation describing input parameters. In the example, these annotations would describe the foreign patent office itself as the source of the docketed items and deadlines.

At block 670, the original annotations describing inputs from FIG. 6A can be reviewed. At block 680, the original annotations can be compared to the plurality of new requirements. It can be determined if the first requirement is duplicated among the plurality of new requirements. For example, if the search report response was docketed at block 620 based on the communication from the foreign associate, but the communication directly from the foreign patent office also contained the search report response requirement, they would be duplicative of each other.

In this case, the first requirement and the duplicative new requirement can be compared and cross-checked. If the requirements are the same, the first requirement does not need to be re-docketed. If the requirements are not the same, they can be reviewed. In the case of review, the annotations from both can be reviewed for context before one of the duplicative requirements is removed or deleted. Thus, an erroneous docket date can be cross-checked and corrected.

In some cases, the plurality of items to be docketed at block 650 can be provided in an Extensible Markup Language (XML) file. In some cases, the plurality of items to be docketed can be provided by a third party such as a governmental agency, a database, an outside firm, a client, an individual, or combinations thereof.

In some cases, the input parameters described in the annotations produced at blocks 630 and 670 can include information such as identity of the docketer, time of docketing, source of docketing, method of docketing, and combinations thereof. In some cases, the first requirement can be produced prior to docketing the first requirement. In some cases, the first requirement can be produced based on an associated task.

In FIG. 6C, an example method 605 can include blocks 615, 625, and 635. At block 625, a list of items to be docketed is received. For example, this list can be from the USPTO, such as in an XML format. For example, it could be a transferred in case, and the XML format may include a file history. The XML list may include, for example, documents and due dates. The XML can be provided by a third-party such as a governmental agency, a database, an outside firm, a client, an individual, or combinations thereof.

At block 625, the docketing system can receive the XML list and process it. In this case, the docketing system can review (by including a docketing back-up or cross-check tool, for example) the XML list and annotate the items on the list, such as by indicating information such as identity of the docketer, time of docketing, source of docketing, method of docketing, and combinations thereof. The annotations can be associated with relevant items from the XML list. The docketing system can then docket each of the items from the XML list.

Subsequently, at block 635, a secondary XML list may be received. For example, while the first XML list may have been scraped from a governmental database such as PAIR, the second XML list may have been received from another firm, such as when the file was transferred.

When the second XML list is received, the docketing system can again annotate the various items therein. After annotation, the docketing system can compare the original XML list with the new XML list, and specifically compare the annotations therein. Duplicative items can be removed during this cross-check. Subsequently, new items that are not duplicative can be docketed.

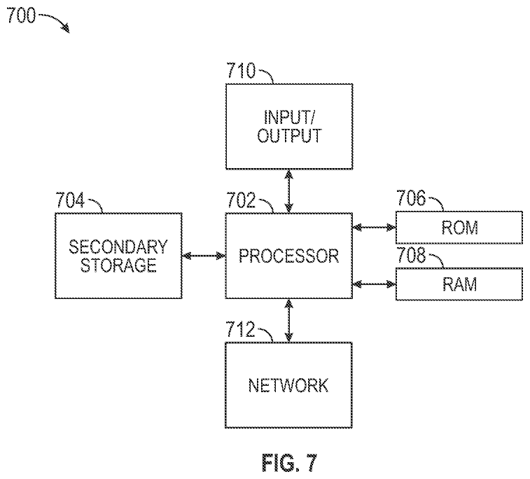

FIG. 7 illustrates a block diagram of an example computing system machine 700 upon which any one or more of the techniques (e.g., methodologies) discussed herein may perform. Machine 700 (e.g., computer system) may include a hardware processor 702 (e.g., a central processing unit [CPU], a graphics processing unit [GPU], a hardware processor core, or any combination thereof), a main memory 704 and a static memory 706, connected via an interconnect 708 (e.g., link or bus), as some or all of these components may constitute hardware for systems 100 or 200 or hardware to operate the services and subsystems and related implementations discussed above.

Specific examples of main memory 704 include Random Access Memory (RAM), and semiconductor memory devices, which may include, in some embodiments, storage locations in semiconductors such as registers. Specific examples of static memory 706 include non-volatile memory, such as semiconductor memory devices (e.g., Electrically Programmable Read-Only Memory [EPROM], Electrically Erasable Programmable Read-Only Memory [EEPROM]) and flash memory devices; magnetic disks, such as internal hard disks and removable disks; magneto-optical disks; RAM; and CD-ROM and DVD-ROM disks.

The machine 700 may further include a display device 710, an input device 712 (e.g., a keyboard), and a user interface (UI) navigation device 714 (e.g., a mouse). In an example, the display device 710, input device 712, and UI navigation device 714 may be a touch screen display. The machine 700 may additionally include a mass storage device 716 (e.g., drive unit), a signal generation device 718 (e.g., a speaker), a network interface device 720, and one or more sensors 730, such as a global positioning system (GPS) sensor, compass, accelerometer, or some other sensor. The machine 700 may include an output controller 728, such as a serial (e.g., universal serial bus (USB), parallel, or other wired or wireless (e.g., infrared [IR], near field communication [NFC], etc.) connection to communicate or control one or more peripheral devices (e.g., a printer, card reader, etc.). In some embodiments the hardware processor 702 and/or instructions 724 may comprise processing circuitry and/or transceiver circuitry.

The mass storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage device 716 constitutes, in at least some embodiments, machine readable media.

The term “machine readable medium” includes, in some embodiments, any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Specific examples of machine readable media include, one or more of non-volatile memory, such as semiconductor memory devices (e.g., Electrically Programmable Read-Only Memory [EPROM], Electrically Erasable Programmable Read-Only Memory [EEPROM]) and flash memory devices; magnetic disks, such as internal hard disks and removable disks; magneto-optical disks; RAM; and CD-ROM and DVD-ROM disks. While the machine readable medium 722 is illustrated as a single medium, the term “machine readable medium” includes, in at least some embodiments, a single medium or multiple media (e.g., a centralized or distributed database, and/or associated caches and servers) configured to store the one or more instructions 724. In some examples, machine readable media includes non-transitory machine readable media. In some examples, machine readable media includes machine readable media that is not a transitory propagating signal.

The instructions 724 are further transmitted or received, in at least some embodiments, over a communications network 726 using a transmission medium via the network interface device 720 utilizing any one of a number of transfer protocols (e.g., frame relay, internet protocol [IP], transmission control protocol [TCP], user datagram protocol [UDP], hypertext transfer protocol [HTTP], etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.15.4 family of standards, a Long Term Evolution (LTE) 4G or 5G family of standards, a Universal Mobile Telecommunications System (UMTS) family of standards, peer-to-peer (P2P) networks, and satellite communication networks, among others).

An apparatus of the machine 700 includes, in at least some embodiments, one or more of a hardware processor 702 (e.g., a central processing unit [CPU], a graphics processing unit [GPU], a hardware processor core, or any combination thereof), a main memory 704, a static memory 706, sensors 730, network interface device 720, antennas 732, a display device 710, an input device 712, a UI navigation device 714, a mass storage device 716, instructions 724, a signal generation device 718, and an output controller 728. The apparatus is configured, in at least some embodiments, to perform one or more of the methods and/or operations disclosed herein. The apparatus is, in some examples, a component of the machine 700 to perform one or more of the methods and/or operations disclosed herein, and/or to perform a portion of one or more of the methods and/or operations disclosed herein.

In an example embodiment, the network interface device 720 includes one or more physical jacks (e.g., Ethernet, coaxial, or phone jacks) or one or more antennas to connect to the communications network 726. In an example embodiment, the network interface device 720 includes one or more antennas 732 to wirelessly communicate using at least one of single-input multiple-output (SIMO), multiple-input multiple-output (MIMO), or multiple-input single-output (MISO) techniques. In some examples, the network interface device 720 wirelessly communicates using Multiple User MIMO techniques. The term “transmission medium” shall be taken to include any intangible medium that is capable of storing, encoding, or carrying instructions for execution by the machine 700, and includes digital or analog communications signals or other intangible media to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as, but not limited to, source code, compiled code, interpreted code, executable code, static code, dynamic code, and the like. Such a computer-readable medium includes any tangible non-transitory medium for storing information in a form readable by one or more computers, such as, but not limited to, read only memory (ROM); random access memory (RAM); magnetic disk storage media; optical storage media; flash memory, etc.

Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as, but not limited to, source code, compiled code, interpreted code, executable code, static code, dynamic code, and the like. Such a computer-readable medium includes, in at least some embodiments, any tangible non-transitory medium for storing information in a form readable by one or more computers, such as, but not limited to, read only memory (ROM); random access memory (RAM); magnetic disk storage media; optical storage media; flash memory, etc.

### Various Notes & Examples

Example 1 is a method of creating a back-up docket, the method comprising: maintaining a primary docketing system; calculating, using a first template, a primary due date associated with a docket item; docketing the primary due date in the primary docketing system; calculating, using a second template, a secondary due date associated with the docket item, wherein the secondary due date is duplicative of the primary due date; and comparing the primary due date with the secondary due date.

In Example 2, the subject matter of Example 1 optionally includes wherein the first docketing system is automated or semi-automated.

In Example 3, the subject matter of any one or more of Examples 1-2 optionally includes selecting the docket item.

In Example 4, the subject matter of any one or more of Examples 1-3 optionally includes providing the first template.

In Example 5, the subject matter of Example 4 optionally includes wherein providing the first template comprises obtaining the first template from an internal system.

In Example 6, the subject matter of any one or more of Examples 1-5 optionally includes providing the second template.

In Example 7, the subject matter of Example 6 optionally includes wherein providing the second template comprises obtaining the second template from an external system maintained by a third party.

In Example 8, the subject matter of Example 7 optionally includes wherein the third party comprise a governmental agency, a foreign associate, an outside firm, or a client company.

In Example 9, the subject matter of any one or more of Examples 1-8 optionally includes docketing the secondary due date in a secondary docketing system.

In Example 10, the subject matter of any one or more of Examples 1-9 optionally includes wherein the docket item comprises one or more communications, deadlines, documents, or combinations thereof.

In Example 11, the subject matter of any one or more of Examples 1-10 optionally includes wherein the docket item comprises a priority date in a patent portfolio.

In Example 12, the subject matter of any one or more of Examples 2-11 optionally includes wherein the priority date comprises a deadline for a continuation filing, a divisional filing, a conversion filing, a non-provisional filing, a PCT filing, a national stage filing, or combinations thereof.

In Example 13, the subject matter of any one or more of Examples 1-12 optionally includes wherein comparing the primary due date with the secondary due date comprises cross-checking the docket item.

In Example 14, the subject matter of any one or more of Examples 9-13 optionally includes identifying one or more errors in the primary docketing system on cross-checking.

In Example 15, the subject matter of any one or more of Examples 10-14 optionally includes rectifying the one or more errors in the primary docketing system.

Example 16 is a system for creating back-up dockets, the system comprising: a first docketing system configured to docket and maintain a patent portfolio in an automated or semi-automated manner, the first docketing system having a first template which when executed calculates a first due date based on a base date; a second docketing system separate from the first docketing system, the second docketing system configured to maintain the patent portfolio, the second docketing system having a second template which when executed calculates a second due date based on a base date; and a back-up docketing tool actuatable for comparing the first due date from the second due date.

In Example 17, the subject matter of Example 16 optionally includes wherein the first docketing system and the second docketing system are maintained by different parties.

In Example 18, the subject matter of any one or more of Examples 16-17 optionally includes wherein the second docketing system is a governmental database.

In Example 19, the subject matter of any one or more of Examples 16-18 optionally includes wherein the back-up docketing system is configurable to select priority items for copying to the first docketing system.

In Example 20, the subject matter of any one or more of Examples 16-19 optionally includes the back-up docketing tool further comprising a cross-check function.

Example 21 is a computer readable medium comprising a memory and a processor, the processor configured to: maintain a first docket in a semi-automated or automated system; select, from the first docket, one or more docketed priority items; identify, in a second docket separate from the first docket, equivalents of the one or more docketed priority items; collect the equivalents of the one or more pocketed priority items; and docket the equivalents of the one or more docketed priority items in the first docket as back-up priority items.

In Example 22, the subject matter of any one or more of Examples 17-21 optionally includes the processor further configured to cross-check the back-up priority items against the one or more docketed priority items in the first docket.

In Example 23, the subject matter of any one or more of Examples 18-22 optionally includes the processor further configured to identify one or more errors in the first docket based on cross-checking.

In Example 24, the subject matter of any one or more of Examples 19-23 optionally includes the processor further configured to rectify the one or more errors in the first docket.

Example 25 is a method comprising: receiving a first requirement, wherein the first requirement is received from a third party; docketing the first requirement in an internal docketing system; creating an annotation in the internal docketing system, the annotation associated with the first requirement, wherein the annotation describes input parameters relating to the origin of the first requirement.

In Example 26, the subject matter of Example 25 optionally includes receiving a list of a plurality of items to be docketed, each of the items associated with a plurality of new requirements; docketing the plurality of new requirements and creating a new annotation describing input parameters for each of the plurality of new requirements; reviewing the annotation describing input parameters of the first requirements; determining whether the first requirement is duplicated among the plurality of new requirements, wherein if the first requirement is among the plurality of new requirements, skipping docketing the first requirement for a second time.

In Example 27, the subject matter of Example 26 optionally includes cross-checking the first requirement as originally docketed against the plurality of items to be docketed.

In Example 28, the subject matter of Example 27 optionally includes correcting the first requirement.

In Example 29, the subject matter of Example 28 optionally includes wherein the plurality of items to be docketed are provided in an Extensible Markup Language (XML) file.

In Example 30, the subject matter of any one or more of Examples 25-29 optionally includes where the docketing system is automated or semi-automated.

In Example 31, the subject matter of any one or more of Examples 25-30 optionally includes wherein the input parameters comprise identity of the docketer, time of docketing, source of docketing, method of docketing, and combinations thereof.

In Example 32, the subject matter of any one or more of Examples 25-31 optionally includes wherein the third party comprises a governmental agency, a database, an outside firm, a client, an individual, or combinations thereof.

In Example 33, the subject matter of any one or more of Examples 25-32 optionally includes comparing the generated first requirement with an official governmental requirement.

In Example 34, the subject matter of any one or more of Examples 25-33 optionally includes generating the first requirement prior to docketing the first requirement.

In Example 35, the subject matter of Example 34 optionally includes generating the first requirement based on an associated task.

In Example 36, the subject matter of any one or more of Examples 24-35 optionally includes wherein the first requirement comprises a due date.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of creating a back-up docket, the method comprising:
maintaining a primary docketing system;
automatically downloading a docket item from a computer, wherein the docket item is posted to the computer by a government entity, the docket item including a base date.
calculating, using a first template, a primary due date associated with the docket item;
docketing the primary due date in the primary docketing system;
calculating, using a second template, a secondary due date associated with the docket item, wherein the secondary due date is duplicative of the primary due date; and
comparing the primary due date with the secondary due date,
wherein comparing the primary due date with the secondary due date comprises;
cross-checking the docket item;
identifying one or more errors in the primary docketing system on cross-checking, and;
rectifying the one or more errors in the primary docketing system.

2. The method of claim 1, further comprising automatically calculating the primary due date and the secondary due date using the base date.

3. The method of claim 1, further comprising providing the first template, wherein providing the first template comprises obtaining the first template from an internal system.

4. The method of claim 1, further comprising providing the second template, wherein providing the second template comprises obtaining the second template from an external system maintained by a third party.

5. The method of claim 4, wherein the third party comprise a governmental agency, a foreign associate, an outside firm, or a client company.

6. The method of claim 1, further comprising docketing the secondary due date in a secondary docketing system.

7. The method of claim 1, wherein the docket item comprises one or more communications, deadlines, documents, or combinations thereof.

8. The method of claim 1, wherein the docket item comprises a priority date in a patent portfolio, wherein the priority date comprises a deadline for a continuation filing, a divisional filing, a conversion filing, a non-provisional filing, a PCT filing, a national stage filing, or combinations thereof.

9. A system for creating back-up dockets, the system comprising:
a first docketing system configured to docket and maintain a patent portfolio in an automated or semi-automated manner, the first docketing system having a first template which when executed calculates a first due date based on a base date;
a second docketing system separate from the first docketing system, the second docketing system configured to maintain the patent portfolio, the second docketing system having a second template which when executed calculates a second due date based on a base date; and
a back-up docketing tool actuatable for comparing the first due date from the second due date, the back-up docketing tool further comprising a cross-check function;
wherein the back-up docketing tool is configurable to select priority items for copying to the first docketing system.

10. The system of claim 9, wherein the first docketing system and the second docketing system are maintained by different parties.

11. The system of claim 9, wherein the second docketing system is a governmental database.

12. A computer readable medium comprising a memory and a processor, the processor configured to:
maintain a first docket in a semi-automated or automated system;
select, from the first docket, one or more docketed priority items;
identify, in a second docket separate from the first docket, equivalents of the one or more docketed priority items;
collect the equivalents of the one or more docketed priority items; and
docket the equivalents of the one or more docketed priority items in the first docket as back-up priority items;
cross-check the back-up priority items against the one or more docketed priority items in the first docket.

13. The computer readable medium of claim 12, the processor further configured to identify one or more errors in the first docket based on crossing-checking.

14. The computer readable medium of claim 13, the processor further configured to rectify the one or more errors in the first docket.

15. A method comprising:
receiving a first requirement, wherein the first requirement is received from a third party;
comparing the first requirement with an official government requirement;
docketing the first requirement in an automated or semi-automated internal docketing system;
creating an annotation in the internal docketing system, the annotation associated with the first requirement, wherein the annotation describes input parameters relating to origin of the first requirement, and the input parameters comprise identity of the docketer, time of docketing, source of docketing, method of docketing, and combinations thereof.

16. The method of claim 15, further comprising:
receiving a list of a plurality of items to be docketed, each of the items associated with a plurality of new requirements;
docketing the plurality of new requirements and creating a new annotation describing input parameters for each of the plurality of new requirements;
reviewing the annotation describing input parameters of the first requirement;
determining whether the first requirement is duplicated among the plurality of new requirements, wherein if the first requirement is among the plurality of new requirements, skipping docketing the first requirement for a second time, and;
cross-checking the first requirement as originally docketed against the plurality of items to be docketed, and correcting the first requirement

17. The method of claim 16, wherein the plurality of items to be docketed are provided in an Extensible Markup Language (XML) file.

18. The method of claim 15, wherein the third party comprises a governmental agency, a database, an outside firm, a client, an individual, or combinations thereof.

19. The method of claim 15, further comprising generating the first requirement prior to docketing the first requirement.

20. The method of claim 15, further comprising generating the first requirement based on an associated task.
